(19) United States
(12) Patent Application Publication
(10) Pub. No.: US 2011/0075176 A1
(43) Pub. Date: Mar. 31, 2011

(54) PRINTER CONTROL APPARATUS, PRINTER CONTROL METHOD, PRINTING SYSTEM, AND STORAGE MEDIUM

(76) Inventor: Motokazu NISHIO, Osaka (JP)

(21) Appl. No.: 12/878,102

(22) Filed: Sep. 9, 2010

(30) Foreign Application Priority Data
Sep. 29, 2009 (JP) 2009-224093

(51) Int. Cl. G06F 3/12; G06F 15/00

(52) U.S. Cl. 358/1.13; 358/1.14; 358/1.15; 358/1.14

(57) ABSTRACT

A printer control apparatus controls plural kinds of printers by use of a universal printer driver which is capable of communicating with the plural kinds of printers via a network and which is capable of supporting the plural kinds of printers. According to the printer control apparatus, a control section causes display means to display a printer list of the plural kinds of printers and a window for accepting an input for selecting available printers from the plural kinds of printers included in the printer list. Thus, a user is allowed to use only printers selected as the available printers. This makes it possible to easily restrict use of an unintended printer while benefiting from a universal printer driver's advantage.

This Nonprovisional application claims priority under 35 U.S.C. §119(a) on Patent Application No. 2009-224093 filed in Japan on Sep. 29, 2009, the entire contents of which are hereby incorporated by reference.

### TECHNICAL FIELD

The present invention relates to a printer control apparatus, a printer control method, a printing system, a program, and a storage medium, each of which utilizes a printer driver.

### BACKGROUND ART

Generally, in a system in which a printer and a personal computer (hereinafter simply referred to as “PC”) are connected to each other, image data or the like created in a PC is transmitted to a printer, and the printer prints the image data on a recording sheet. In order that the image data created in the PC is printed by the printer in this way, software called “printer driver” needs to be installed in a PC.

Examples of the printer driver include a so-called universal printer driver, which can support a plurality of printers by itself. As for the universal printer driver, various techniques have been conventionally proposed.

For example, according to universal printer drivers disclosed in Patent Literatures 1 and 2, a search is conducted so that printers connected to a network are extracted, a printer to be used is selected from the printers thus extracted, and a printer driver user interface (UI) corresponding to the printer thus selected is then displayed on a display screen of a PC.

Specifically, Patent Literature 1 discloses a universal printer driver which can support a plurality of printers and which displays, on a screen, a UI which shows an appearance of a printer corresponding to model of a printer selected as a destination printer.

Patent Literature 2 discloses a universal printer driver in which (i) a search is conducted so that printers connected to a network are extracted, (ii) a user selects a printer from the printers thus extracted, and (iii) print data suitable for the printer thus selected is created.

Meanwhile, each of Patent Literatures 3 through 5 discloses a conventional printer driver technique. Patent Literature 3 discloses a printer driver technique in which information indicating whether use of a specific printer by a specific user is permissible or not is registered in an authorization table so as to be managed in a server. Patent Literature 4 discloses a printer driver technique in which, in a system in which drivers are installed from a server, a specific user is not allowed to install a driver for a specific printer. Patent Literature 5 discloses a printer driver technique in which what kind of function of a printing apparatus is restricted is managed, for each user, in a server, and the function restriction is placed when a driver is installed.

### CITATION LIST

### Patent Literature 1

Japanese Patent Application Publication, Tokukai, No. 2000-225754 (Publication Date: Aug. 15, 2000)

### Patent Literature 2

Japanese Patent Application Publication, Tokukai, No. 2008-186463 (Publication Date: Aug. 14, 2008)

### Patent Literature 3

Japanese Patent Application Publication, Tokukai, No. 2008-123058 (Publication Date: May 29, 2008)

### Patent Literature 4

Japanese Patent Application Publication, Tokukai, No. 2006-172093 (Publication Date: Jun. 29, 2006)

### Patent Literature 5

Japanese Patent Application Publication, Tokukai, No. 2004-220532 (Publication Date: Aug. 5, 2004)

### SUMMARY OF INVENTION

### Technical Problem

According to a conventional universal printer driver, image data can be outputted to various models of printers, as long as a single printer driver is installed. However, conventional universal printer drivers are designed only for improving this advantage. Accordingly, there is no technical idea of restricting use of a printer of a specific model. That is, conventional printer drivers do not have a function to restrict use of a printer of a specific model.

Meanwhile, Patent Literature 4 discloses a method in which installing of a printer driver is prohibited. However, the method disclosed in Patent Literature 4 cannot solve the above problem since every kind of printers becomes available in a case where a conventional universal printer driver is installed.

Moreover, the system disclosed in Patent Literature 3, in which information indicating whether use of a specific printer by a specific user is permissible or not is managed in an authorization table, has its own disadvantage. In the system disclosed in Patent Literature 3, all the printer drivers which are not universal printer drivers (hereinafter referred to as “non-universal printer drivers”) need to be supported by this system. This means that it is necessary (i) to obtain drivers which are supported by the system in consideration of a printer environment to be used (i.e., which models are connected to a network) and (ii) to replace all the drivers installed in all the personal computers with the drivers which are supported by the system. This forces an administrator to carry out complicated setting operations.

In a universal printer driver, setting screens (UI) for respective models of printers that are selected as destination printers are prepared in advance. Moreover, according to a universal printer driver, any printers which are connected to a network and which are compatible with the universal printer driver can be used. That is, a universal printer driver can support plural models of printers and has plural types of setting screens. Accordingly, in a case where a user mistakenly selects, as a destination printer, a printer that is not usually used, a setting screen that is different from the one that is usually used is displayed. This may confuse the user. In order to prevent such an unnecessary confusion of a user, an administrator must change the setting so that the user cannot select a printer that is not recommended. It should be noted that, in this respect, a conventional non-universal printer driver does not cause such an unnecessary confusion unless a driver for an unused printer is installed.

An object of the present invention is to provide a printer control apparatus, a printer control method, a printing system, a program, and a storage medium, each of which can easily restrict use of an unintended printer while benefiting from a universal printer driver's advantage of being capable of supporting plural types of printers.

### Solution to Problem

A printer control apparatus of the present invention is a printer control apparatus which controls plural kinds of printers by use of a universal printer driver which is capable of communicating with the plural kinds of printers via a network and which is capable of supporting the plural kinds of printers, the printer control apparatus includes: a display control section which causes display means to display a printer list of the plural kinds of printers and a window for accepting an input for selecting at least one available printer from the plural kinds of printers included in the printer list; and an available printer restricting section which allows a user to use only said at least one available printer.

A printer control method of the present invention is a printer control method for controlling plural kinds of printers by use of a universal printer driver which communicates with the plural kinds of printers via a network and which is capable of supporting the plural kinds of printers, the printer control method including the steps of: causing display means to display a printer list of the plural kinds of printers and a window for accepting an input for selecting at least one available printer from the plural kinds of printers included in the printer list; and allowing a user to use only said at least one available printer.

According to the arrangement, even in a case where a universal printer driver, which can support plural kinds of printers, is used, it is possible to prevent a user from using an unintended printer. For example, an administrator can restrict printers available to general users.

Moreover, since (i) a universal printer driver, which can support plural kinds of printers, is used and (ii) printers available to users are restricted, it is possible to greatly reduce a burden of an administrator who determines which printers are available and which printers are not available to users. For example, in a case where printers correspond one-to-one with respective printer drivers, it is necessary to adjust setting of each of the printer drivers in a personal computer (printer control apparatus) or the like in which the printer drivers are installed, in order to determine which printers are available and which printers are not available to users. However, according to the printer control apparatus of the present invention, there is no need for carrying out such an operation. That is, only by adjusting setting of a single printer driver, it is possible to determine which printers are available and which printers are not available to users. For example, in a case where setting as to which printers are available and which printers are not available to users are adjusted so as to be the same for plural users (printer control apparatuses) such as users belonging to a group, it is possible to greatly reduce a burden of adjusting such setting.

According to the arrangement of the present invention, it is thus possible to easily restrict use of an unintended printer while benefiting a universal printer driver's advantage of being capable of supporting plural kinds of printers.

A printer control method of the present invention is a printer control method for controlling plural kinds of printers by use of a universal printer driver which communicates with the plural kinds of printers via a network and which is capable of supporting the plural kinds of printers, the printer control method including the steps of: causing display means to display, in a server in which the universal printer driver is installed and which is connected to the network, a printer list of the plural kinds of printers and a window for accepting an input for selecting at least one available printer from the plural kinds of printers included in the printer list; allowing a user to use only said at least one available printer; and causing the universal printer driver thus set in the steps (a) and (b) to be installed in a printer control apparatus connected to the server.

According to the arrangement, setting of the universal printer driver installed in the server is determined by executing, in the server, the step (a) of causing the display means to display the printer list of the plural kinds of printers and the window for accepting an input for selecting available printers and the step (b). By causing the universal printer driver whose setting is determined in the steps (a) and (b) to be installed in a printer control apparatus from the server, the universal printer driver whose setting has been determined can be used in the printer control apparatus.

According to the present invention, it is thus possible to collectively determine setting of a printer driver in a server, thereby eliminating the need for determining setting of the printer driver in each printer control apparatus in which the printer driver is installed from the server. This further reduces a burden of an administrator who determines setting of a printer driver in a printer control apparatus.

### ADVANTAGEOUS EFFECTS OF INVENTION

As described above, according to the arrangement of the present invention, it is possible to easily restrict use of an unintended printer while benefiting from a universal printer driver's advantage of being capable of supporting plural kinds of printers.

### BRIEF DESCRIPTION OF DRAWINGS

FIG. 1 is a block diagram illustrating a configuration of a printing system of the present embodiment.

FIG. 2 is an explanatory view illustrating an example of how a property window is displayed in a case where a user has a printer administrator authority in a printer driver of the present embodiment.

FIG. 3 is an explanatory view illustrating an example of how the property window is displayed in a case where a user does not have a printer administrator authority in the printer driver of the present embodiment.

FIG. 4 is an explanatory view illustrating which printers are available to a printer administrator and general printer users in the printing system illustrated in FIG. 1.

FIG. 5 is a block diagram illustrating a configuration of a personal computer illustrated in FIG. 1.

FIG. 6 is a block diagram illustrating, in detail, a configuration of a control section shown in FIG. 5.

FIG. 7 is an explanatory view illustrating a user interface for print setting of a first printer, which user interface is created by a first print setting UI creating section shown in FIG. 6.

FIG. 8 is an explanatory view illustrating a user interface for print setting of a second printer, which user interface is created by a second print setting UI creating section shown in FIG. 6.

FIG. 9 is an explanatory view illustrating a user interface for creating a printer management list for a printer administrator, which user interface is created by a printer management list for administrator setting UI creating section shown in FIG. 6.

FIG. 10 is an explanatory view illustrating a user interface for creating a printer management list for general users, which user interface is created by a printer management list for general user setting UI creating section shown in FIG. 6.

FIG. 11 is an explanatory view showing a content of an executable step management table shown in FIG. 6.

FIG. 12 is a flow chart showing how a printer driver of an embodiment of the present invention operates in a case where a setting program for printer administrator is executed.

FIG. 13 is a flow chart showing how a print port is created in an embodiment of the present invention.

FIG. 14 is a flow chart showing another example of how a print port is created in an embodiment of the present invention.

FIG. 15 is a flow chart showing how a printer driver of an embodiment of the present invention operates in a case where a setting program for general users is executed.

FIG. 16 is an explanatory view showing an example of a window showing a default printer, which window is displayed instead of the window of FIG. 10 in a case where a general printer user is not allowed to change a default printer in processing shown in FIG. 15.

FIG. 17 is an explanatory view illustrating an example of how the user interface illustrated in FIG. 9 is displayed in a case where a general printer user changes a default printer from a first printer (monochrome printer) set by a printer administrator to a second printer (color printer).

FIG. 18 is a flow chart showing how a printer driver of an embodiment of the present invention operates in a case where printing is executed by using an OS standard TCP/IP port.

FIG. 19 is a flow chart showing how a printer driver of an embodiment of the present invention operates in a case where printing is executed by using a unique port.

FIG. 20 is a flow chart showing another example of how a printer driver of an embodiment of the present invention operates in a case where the setting program for general users is executed.

FIG. 21 is a block diagram illustrating a configuration of a printing system of another embodiment of the present invention.

FIG. 22 is an explanatory view showing how client PCs, a server, and first through third printers are connected in the printing system illustrated in FIG. 21 and which of the printers is available to a printer administrator and general printer users.

FIG. 23 is a flow chart showing an example of how a printer driver operates in a case where a setting program for general users is executed in a client PC illustrated in FIG. 21.

FIG. 24 is a flow chart showing another example of how a printer driver operates in a case where a setting program for general users is executed in a client PC illustrated in FIG. 21, which flow chart shows a case where a general printer user is not allowed to change a default printer.

FIG. 25 is an explanatory view illustrating another example of the user interface for general printer users illustrated in FIG. 10.

FIG. 26 is an explanatory view illustrating a printer property setting window displayed in a case where a print port created by a port management module shown in FIG. 6 is a standard port.

FIG. 27 is an explanatory view illustrating a printer property setting window displayed in a case where a print port created by a port management module 311 shown in FIG. 6 is a unique port.

### DESCRIPTION OF EMBODIMENTS

### Embodiment 1

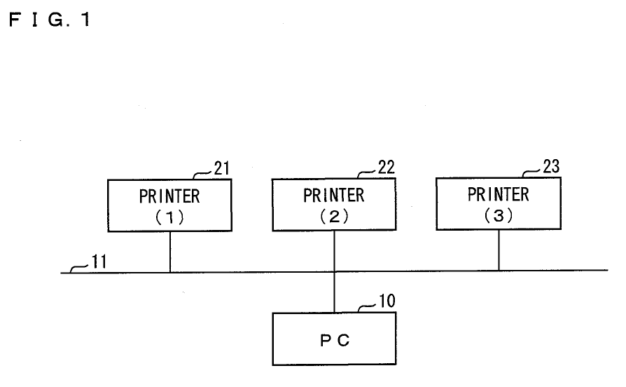

An Embodiment of the present invention is described below with reference to the drawings. FIG. 1 is a block diagram illustrating a configuration of a printing system of the present embodiment. As illustrated in FIG. 1, a personal computer (hereinafter simply referred to as “PC”) 10 is connected to a plurality of printers (first printer 21, second printer 22, and third printer 23) via a network 11.

As login authorities in the PC 10 (printer control apparatus), there are administrator authority and general user authority. A user can log into the PC 10 by using one of these login authorities.

In the PC 10, a printer driver is installed. This printer driver is a so-called universal printer driver, which can support a plurality of printers by itself.

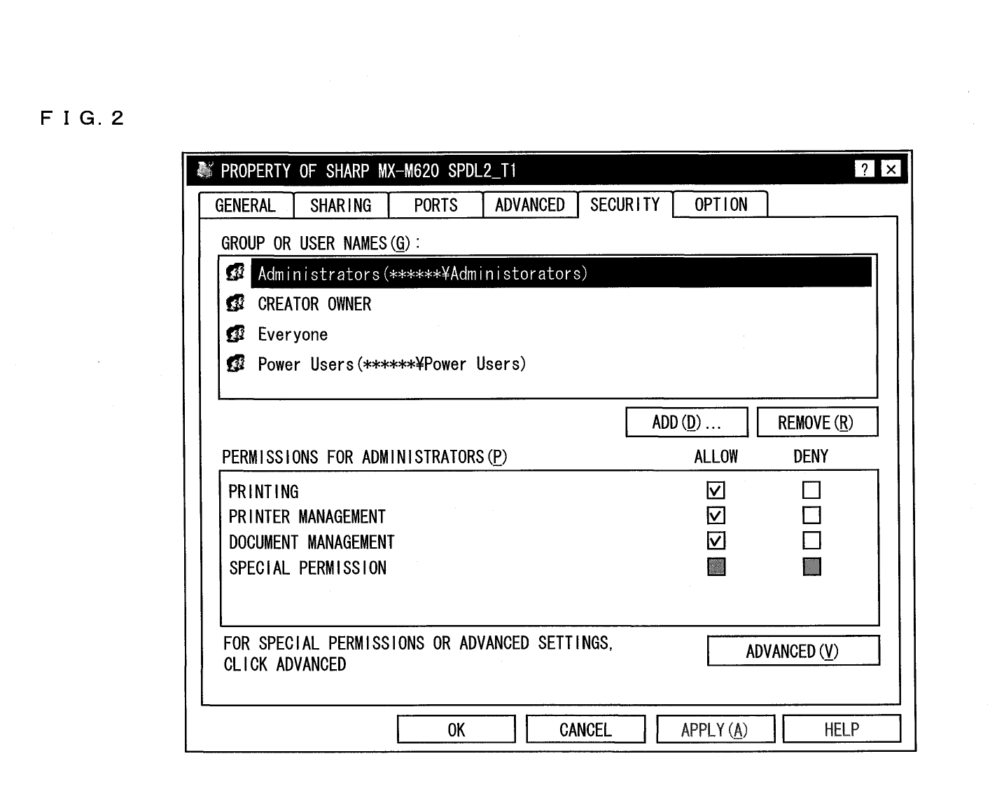

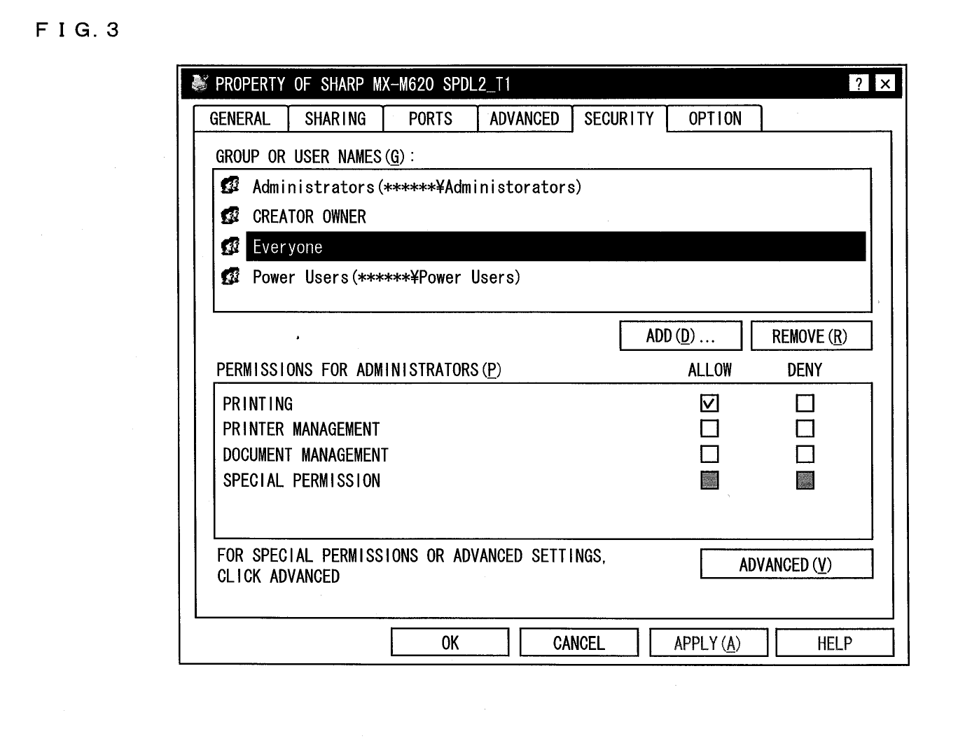

In a property of the printer driver installed in the PC 10, a printer administrator authority is defined. FIGS. 2 and 3 each illustrate an example of the property of the printer driver. FIG. 2 is an explanatory view illustrating an example of the property of the printer driver displayed in a case where a user has a printer administrator authority. FIG. 3 is an explanatory view illustrating an example of the property of the printer driver displayed in a case where a user does not have a printer administrator authority.

A user who logs into the PC 10 by using the administrator authority, i.e., an administrator of the PC 10 has a printer administrator authority. As shown in FIG. 2, in a “Security” tab of a user interface of the printer driver, the user who has the printer administrator authority can set a content (range) of the printer administrator authority, and can also set a content (range) of a general printer user authority (a checkbox of the “PRINTER MANAGEMENT” in FIG. 2 is checked). Meanwhile, a user who logs into the PC 10 by using the general user authority has a general printer user authority. As shown in FIG. 3, the user who has the general printer user authority is not allowed to change settings of the driver (a checkbox of the “PRINTER MANAGEMENT” in FIG. 3 is not checked).

According to a printer driver of an embodiment of the present invention, an administrator who has the printer administrator authority can select available printers in a printer driver installed in the PC 10. As such, according to the printer driver of the present embodiment, a user who does not have a printer administrator authority, i.e., a user who has only a general printer user authority (hereinafter simply referred to as “general printer user”) can use only printers that are selected as available printers by the administrator who has the printer administrator authority (hereinafter simply referred to as “printer administrator”). That is, according to the printer driver of the present embodiment, general printer users are not allowed to use printers that are not printers selected, by the printer administrator, as printers available to the general printer users. This makes it possible to prevent general printer users from using printers that are not intended by the printer administrator even if a universal printer driver is used as a printer driver in the PC 10.

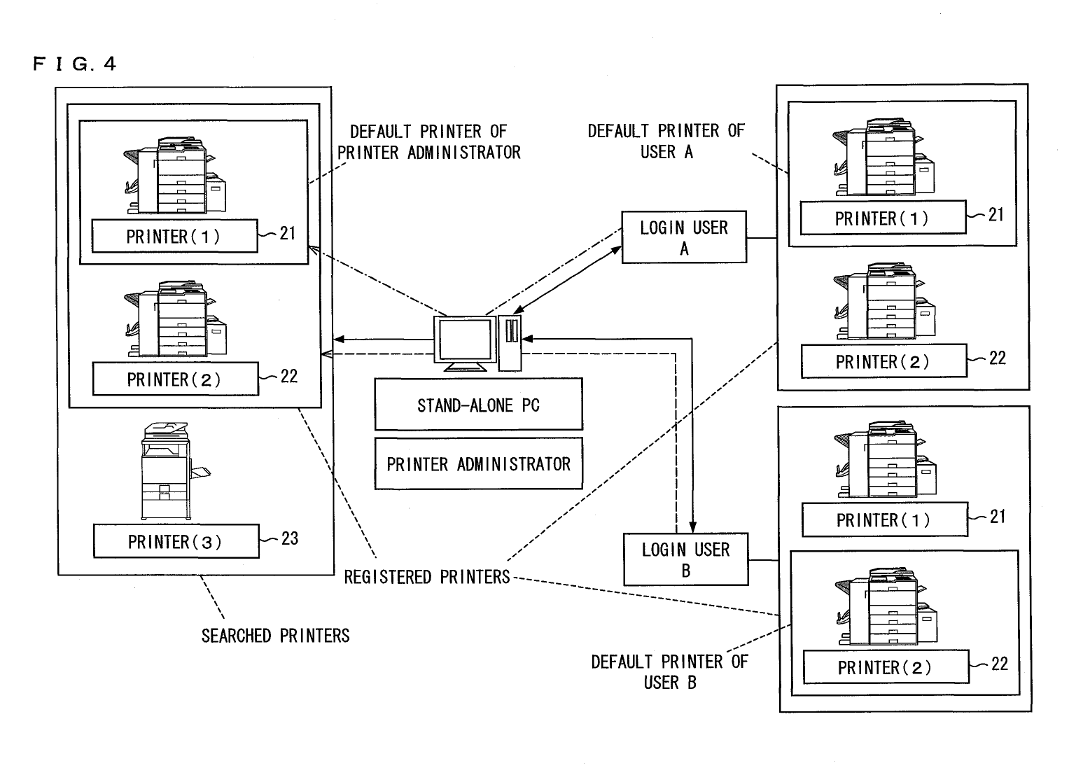

With reference to FIG. 4, the following description deals with an example in which the printer administrator imposes restrictions on printers available to general printer users. FIG. 4 is an explanatory view illustrating an example of which printers are available to the printer administrator and the general printer users in the printing system illustrated in FIG. 1.

In a case where the PC 10 is connected to the first printer 21, second printer 22, and third printer 23 via the network 11 as illustrated in FIG. 1, the first printer 21, second printer 22, and third printer 23 are extracted as a result of a search conducted in the PC 10. As illustrated in FIG. 4, login users A and B, who are general printer users, are allowed to use only the first printer 21 and the second printer 22, but are not allowed to use the third printer 23 by the printer administrator.

Meanwhile, the login users A and B can select, as a default printer, a favorite one from the available printers 1 and 2. For example, the login user A selects the first printer 21 as a default printer, and the login user B selects the second printer 22 as a default printer.

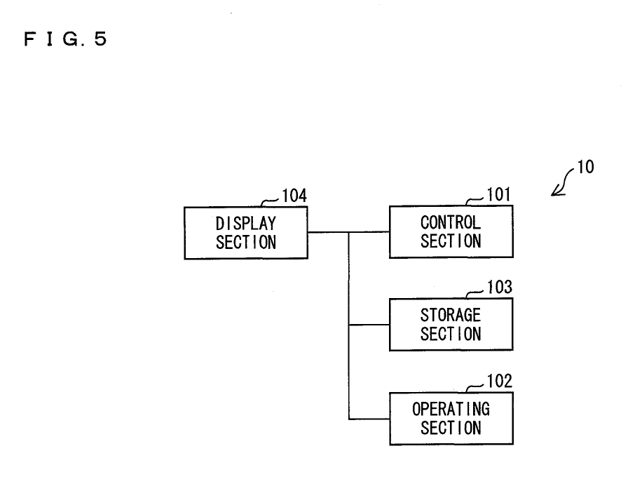

FIG. 5 is a block diagram illustrating a configuration of the PC 10 illustrated in FIG. 1. As illustrated in FIG. 5, the PC 10 includes a control section 101 (display control section, available printer restricting section, administrator authority judging section, searching section, printer list creating section, apparatus information acquiring section, print port creating section, default printer information adding section, print port changing section, and print data outputting section), an operating section 102, a storage section 103, and a display section (display means) 104.

The control section 101 causes the display section 104 to display a user interface. In addition, the control section 101 controls all the functions of the interface. For example, the control section 101 judges, on the user interface, which printer has been selected as a default printer, and carries out, in accordance with a result of the judgment, processing such as processing of changing the user interface (option, print settings) and processing of changing a print port.

The operating section 102 includes a mouse and a keyboard for example, and supplies, to the control section 101, information inputted by a user via these members. The storage section 103 is constituted by a storage medium such as a hard disc or a memory, and stores information such as registered printers, a default printer, and printer configuration information. The display section 104 includes a display device, and causes the display device to display various kinds of information in accordance with an instruction from the control section 101.

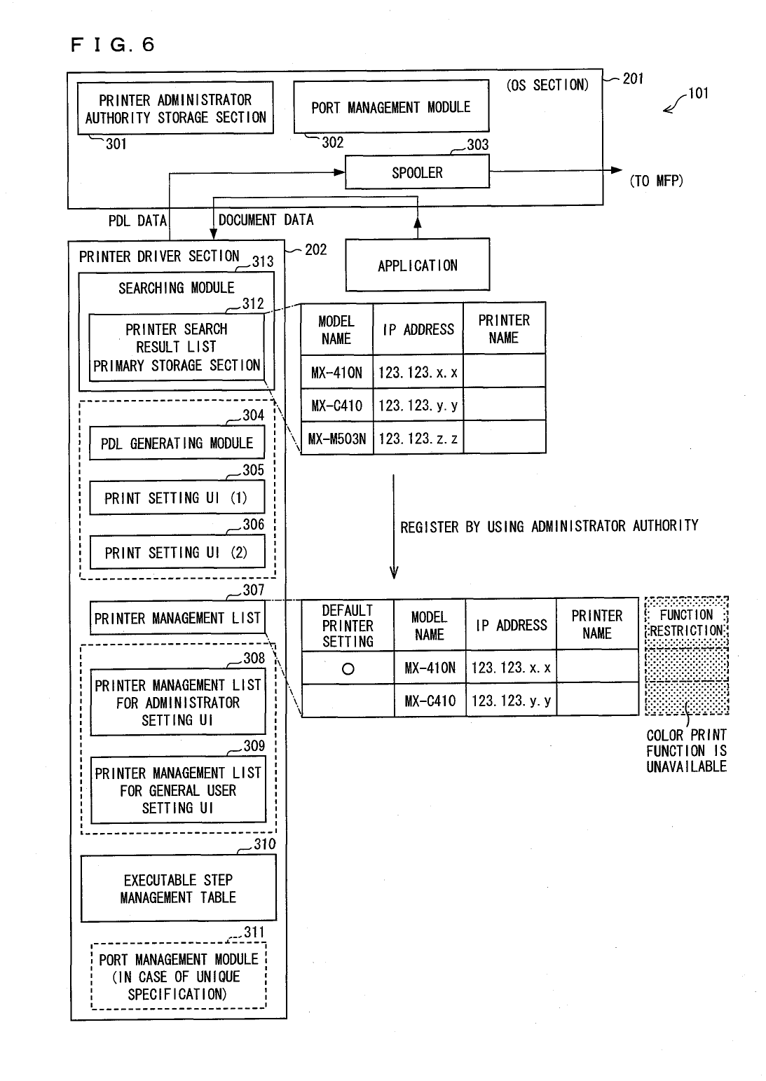

FIG. 6 is a block diagram illustrating, in detail, a configuration of the control section 101 illustrated in FIG. 5. As illustrated in FIG. 6, the control section 101 includes an OS section (administrator authority judging section, print data outputting section) 201, and a printer driver section (apparatus information acquiring section, default printer information adding section, available printer restricting section) 202.

The OS section 201 is constituted by an OS (operating system) installed in the PC 10, and includes a printer administration authority storage section (administrator authority judging section) 301, a port management module (print port changing section) 302, and a spooler 303.

The printer administrator authority storage section 301 stores information concerning available printers (see FIGS. 2 and 3) and the like that are selected by the printer administrator, and stores information (user name, password etc.) necessary for a user to log into the PC 10 by using an administrator authority or a general user authority.

The information (user name, password etc.) necessary for a user to log into the PC 10 by using an administrator authority or a general user authority is normally registered in the OS. As such, this information may be obtained by reference to the one registered in the OS.

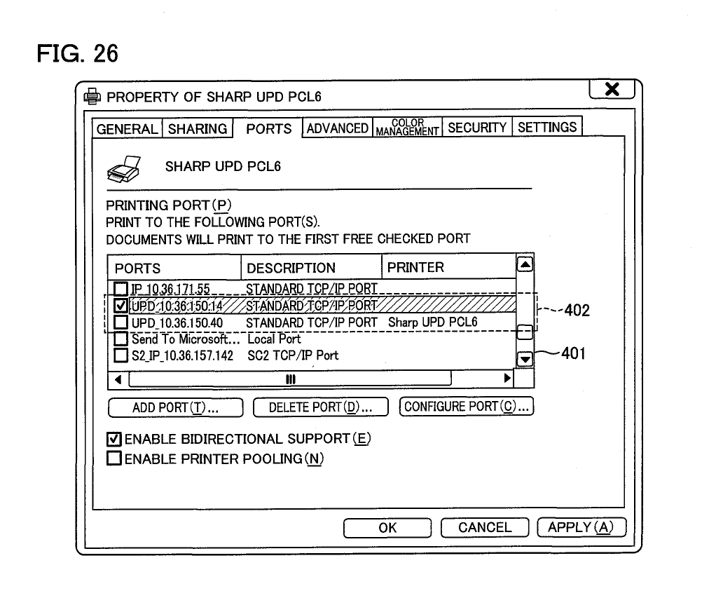

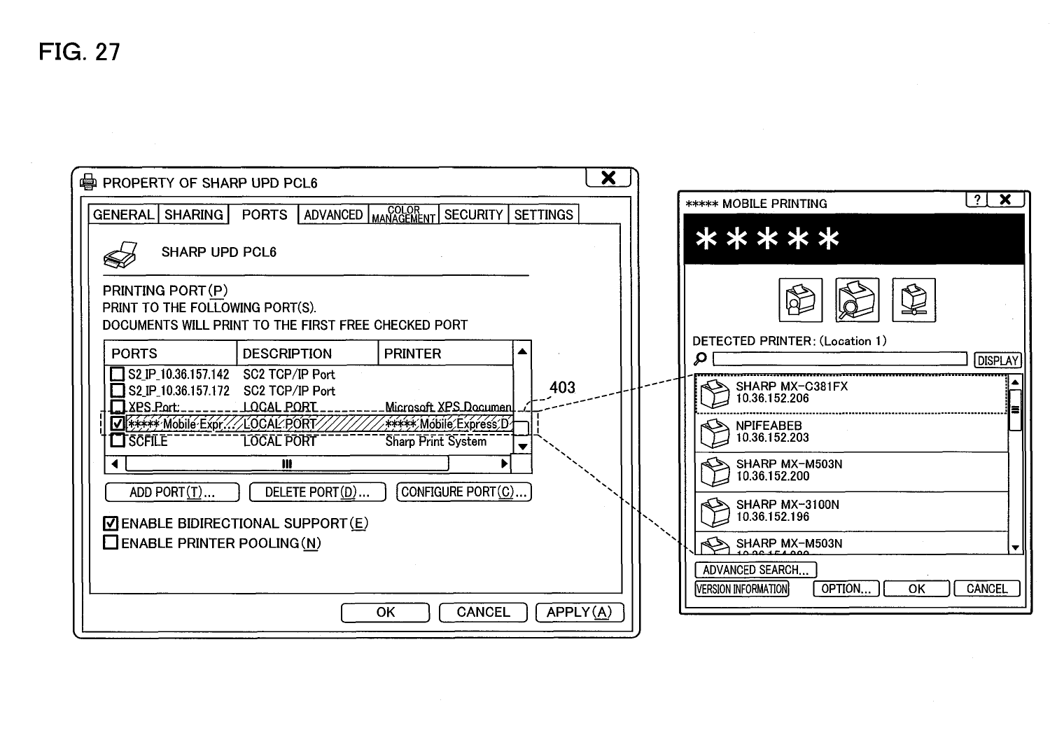

As illustrated in FIGS. 26 and 27, the port management module 302 manages print ports. Note that a single print port is allocated to each printer. FIG. 26 is an explanatory view illustrating a property setting window displayed in a case where a print port is a standard port, which property settings window is created by the port management module 302. FIG. 27 is an explanatory view illustrating a property setting window displayed in a case where a print port is a unique port, which property settings window is created by the port management module 302.

In FIG. 26, a display 401 shows all print ports registered in the OS, and a display 402 shows that ports corresponding to respective printers that are registered as available printers by the printer administrator are registered in the OS. A print port can be manually changed by checking a check box of a port to be used.

The spooler 303 temporarily stores a print request from the printer driver section 202 so that the print request is efficiently made to an MFP (multi function printer).

The printer driver section 202 is constituted by a printer driver, and includes a searching module (searching section) 313, a PDL (Page Description Language) generating section 304, a first print setting UI (user interface) creating section 305, a second print setting UI (user interface) creating section 306, a printer management list (available printer restricting section) 307, a printer management list for administrator setting UI (user interface) creating section (display control section) 308, a printer management list for general user setting UI (user interface) creating section (display control section) 309, an executable step management table 310, and a port management module (print port creating section) 311.

The searching module 313 conducts a search for printers based on information inputted to user interface for searching which is displayed by the printer driver. A search result is stored in a printer search result list primary storage section (printer list creating section) 312. In the present embodiment, information for the printer search is inputted by the printer administrator. The search is carried out by the following methods, each of which is aimed at printers whose power is on at the start of the search: (i) a method of extracting all printers connected to the network 11, (ii) a method of extracting printers having designated IP addresses, (iii) a method of extracting printers of designated models, and (iv) a method of extracting printers encompassed within a designated subnet. For example, in the method of extracting printers having designated IP addresses, only printers located within a predetermined range (e.g., printers located on an identical floor of a building) can be extracted, provided that IP addresses of printers are set based on location of the printers. The search result stored in the printer search result list primary storage section 312 includes printer model names, IP addresses, printer names.

The PDL generating module 304 generates a language (PDL) that describes an image to be outputted to a printer and instructs the printer to print a text and a graphical image created in a computer.

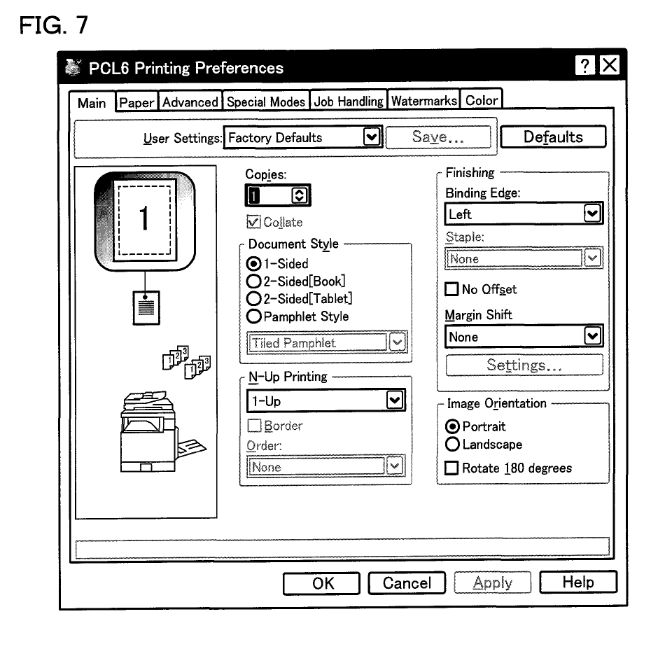

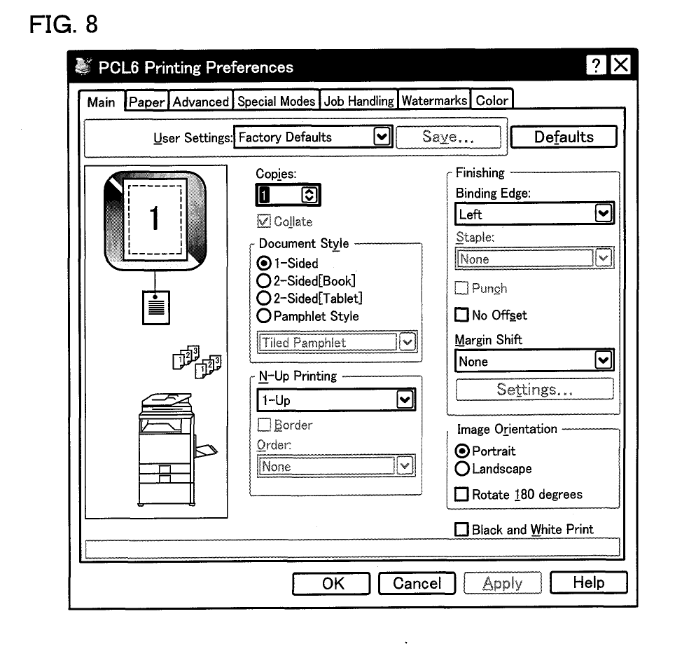

The first print setting UI creating section 305 creates a user interface illustrated in FIG. 7 for print setting of the first printer 21. The second print setting UI creating section 306 creates a user interface illustrated in FIG. 8 for print setting of the second printer 22.

The printer management list 307 includes a management list for the printer administrator (management list that is created by the printer management list for administrator setting UI creating section 308) and a management list for general printer users (management list that is created by the printer management list for general user setting UI creating section 309). In the printer management list 307, the printer administrator can change settings of a specific printer so as to restrict functions of the specific printer. In a case where functions of a printer are restricted, the user interface is changed so that a monochrome print mode is forcibly selected, i.e., a user is not allowed to select a color print mode. In this case, an option for the color print mode is not displayed or is grayed out on the user interface.

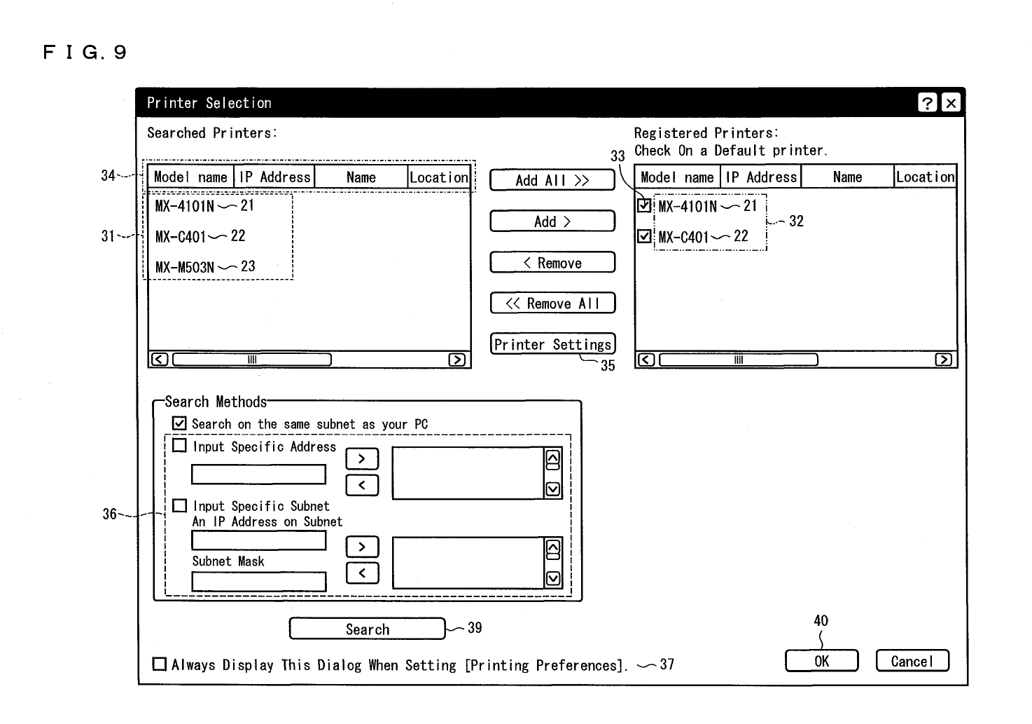

The printer management list for administrator setting UI creating section 308 creates a printer management list for administrator setting user interface illustrated in FIG. 9 for creating the management list for the printer administrator. The printer management list for administrator setting UI creating section 308 creates the management list for the printer administrator based on printer administrator's setting made on this user interface. This management list contains information such as selected default printer, printer model name, IP address, printer name, and function restriction such as availability of the color print mode.

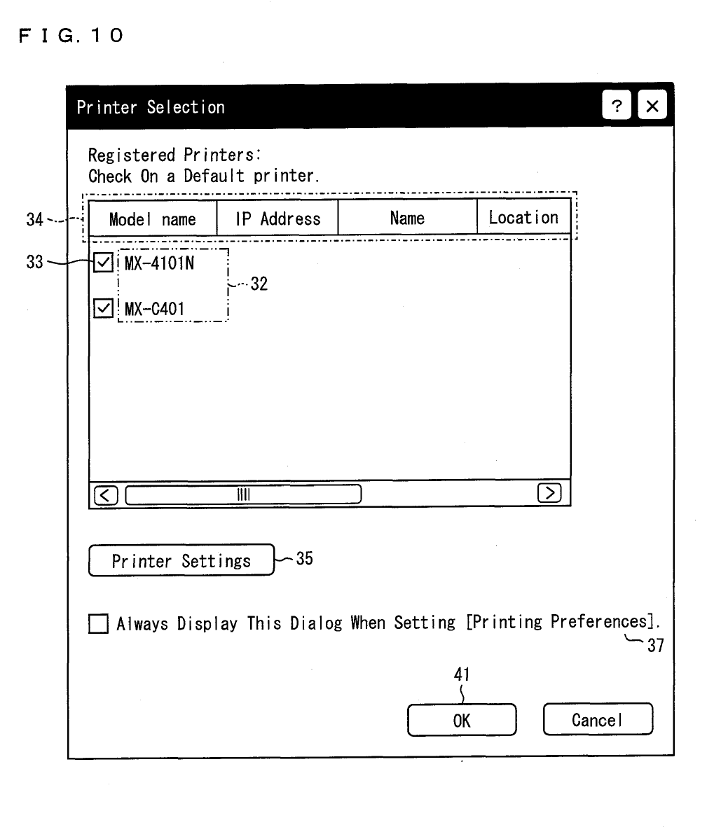

The printer management list for general user setting UI creating section 309 creates a printer management list for general user setting user interface illustrated in FIG. 10 for creating the management list for general printer users. The printer management list for general user setting UI creating section 308 creates the management list for general printer users based on general user's setting made on this user interface.

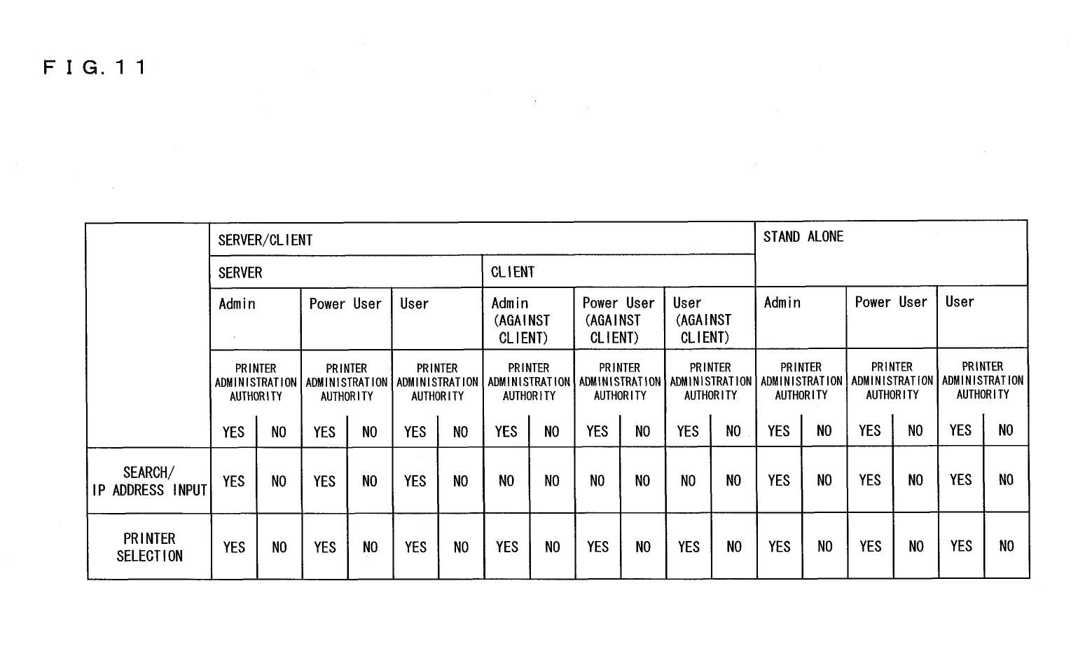

FIG. 11 is an explanatory view for explaining a content of the executable step management table 310 shown in FIG. 6. The executable step management table 310 shows what kind of processing can be executed by a user (printer administrator, general user, etc.). Note that such executable processing varies depending on whether the user has a printer administrator authority or not. Specifically, the executable step management table 310 shows whether or not the user can input IP address in conducting a search for printers and whether or not the user can select a printer to be used.

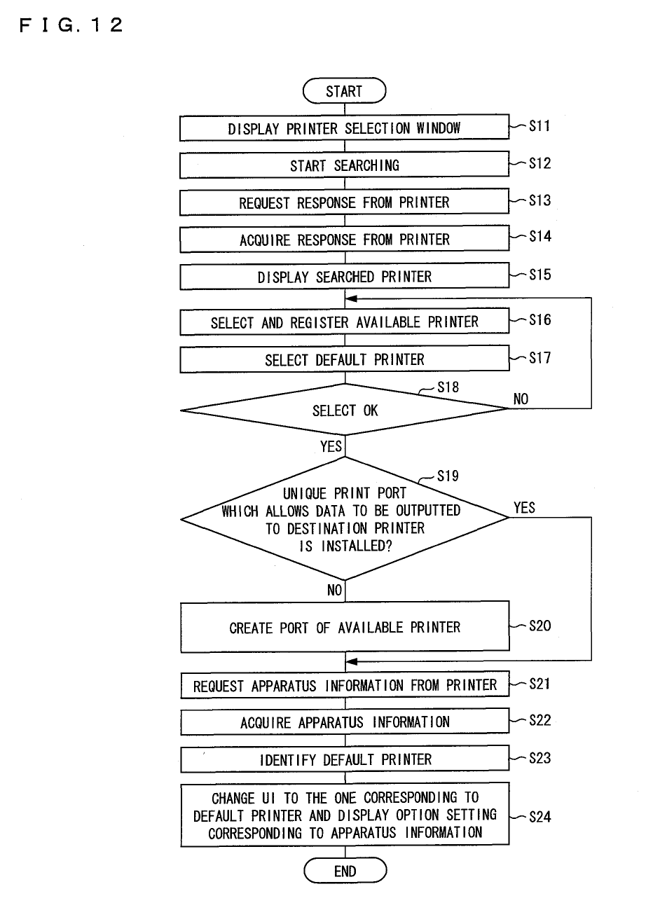

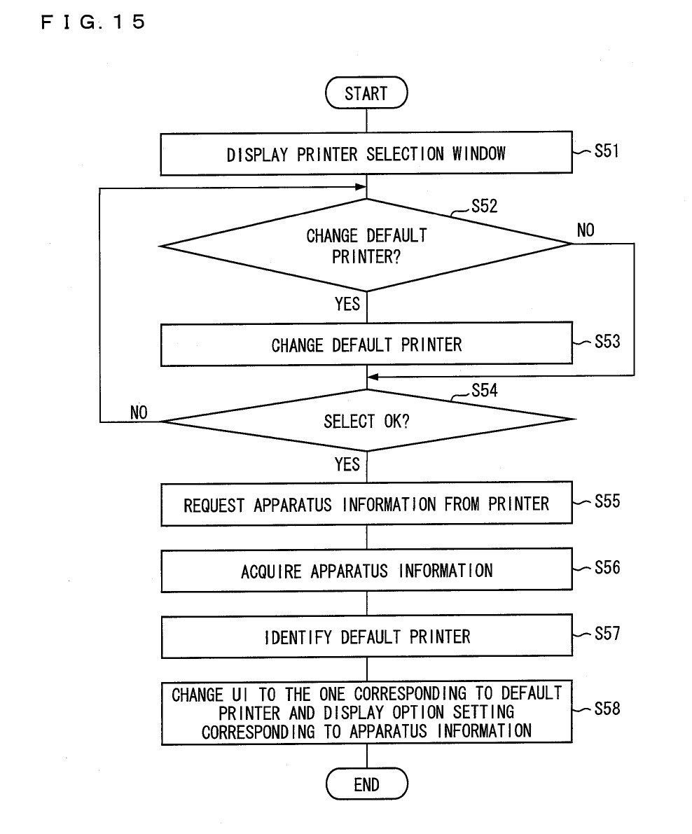

In accordance with the setting in the executable step management table 310, the control section 101 determines a user interface based on what kind of authority a user has, and then causes the interface to be displayed on the display section 104. Specifically, with reference to the executable step management table 310, the control section 101 causes, in S11 of FIG. 12, the display section 104 to display a selection window of FIG. 9, and causes, in S51 of FIG. 15, the display section 104 to display a selection window of FIG. 10 in replacement of the selection window of FIG. 9.

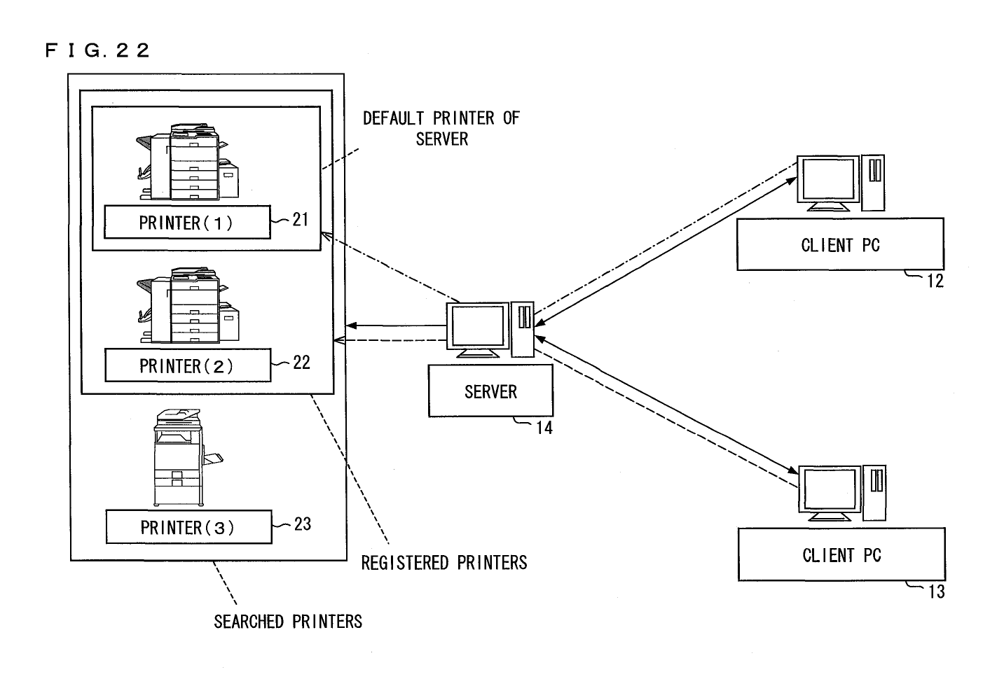

For example, the printer selection window of FIG. 9 is displayed in a case where a user of the PC 10 is a printer administrator (a user who has a printer administrator authority) in the printing system illustrated in FIGS. 1 and 4. This is because the user is allowed to conduct a search for printers and select available printers. Meanwhile, the printer selection window of FIG. 10 is displayed in a case where users of client PCs 12 and 13 are general printer users (users who do not have a printer administrator authority) in a printing system illustrated in FIGS. 21 and 22. This is because the users are not allowed to select available printers. Further, the printer selection window of FIG. 10 is displayed, for example, in a case where the “SEARCH/IP ADDRESS INPUT” is “NO” in FIG. 11. This is because a user is not allowed to use IP addresses in conducting a search for printers and designating printers. Further, no printer selection window is displayed on a client side (client is not allowed to select printers) in a case where both of the “SEARCH/IP ADDRESS INPUT” and “PRINTER SELECTION” is “NO”.

In a case where the printer driver section 202 has a unique specification (specification that is different from a specification defined by an OS of the OS section 201), the port management module 311 manages a unique port. As shown in FIG. 27, the unique port appears to be managed on the OS in a similar manner to a single standard port (see the display 403). However, in a case where a print port is a unique port, the print port is converted, in the port management module 311, into a port corresponding to a printer. A right portion of FIG. 27 shows that the print port is converted, in the port management module 311, into any one of registered print ports.

The window (printer selection window) in the printer management list for administrator setting user interface illustrated in FIG. 9 that is displayed on the PC 10 has a searched printer list display part 31 and a registered printer list display part 32. On the searched printer list display part 31, printers that are extracted as a result of a search conducted in the PC 10 by the printer administrator are displayed. On the registered printer list display part 32, printers that are registered, as printers available to general printer users, by the printer administrator are displayed.

FIG. 9 shows a case where the printers 21 and 22 are extracted as a result of a search conducted in the PC 10. In FIG. 9, a list of the printers thus extracted is displayed on the searched printer list display part 31. Meanwhile, nothing is displayed on the registered printer list display part 32. The administrator registers printers available to general users in the registered printer list display part 32 by clicking the “ADD” button and the “REMOVE” button located in a central part of the window. The administrator also registers a default printer by putting a check mark 33 into a checkbox.

On the searched printer list display part 31, printer information 34 (name, IP address, and location) of each of the extracted printers is displayed as a list in addition to printer model names. Moreover, there may be a button 35 for providing detailed information of the printers, and by clicking the button 35, detailed information indicative of printer functions such as a post-processing function may be displayed. This detailed information is supplied from a printer in an HTML format by inputting, in a Web browser, an IP address of the printer. Thus, the detailed information can be displayed on a PC as a Web page.

The window (printer selection window) in the printer management list for general user setting user interface illustrated in FIG. 10 that is displayed on the PC 10 has a registered printer list display part 38. The registered printer list display part 38 corresponds to the registered printer list display part 32 in the printer management list for administrator setting user interface illustrated in FIG. 9. On the registered printer list display part 38, printers that are available to general printer users and default printers 33 are displayed. On the registered printer list display part 38, a general printer user can change the default printer. In accordance with the change, printer driver UI (option, print setting) and print port are changed.

With reference to the flow chart of FIG. 12, the following description deals with how a printer driver of the present embodiment operates in a case where a setting program for administrator is executed in the PC 10 configured as above.

A printer administrator causes the PC 10, in which a printer driver (universal printer driver) is installed, to display a property of the printer driver. Thus, processing starts.

As a result of this operation, the printer management list for administrator setting user interface (printer selection window) illustrated in FIG. 9 is displayed (S11).

Next, the printer administrator inputs a search condition to a search condition input part 36 of the printer management list for administrator setting user interface (printer selection window). By clicking a search button 39, a search for printers is started (S12). Examples of the search condition inputted to the search condition input part 36 include a subnet to be searched and a printer's IP address. In a case where no search condition is inputted in the search condition input part 36, printers whose power is on and which are connected to the network 11 are all extracted.

In this search, the control section 101 requests response from the printers (the first printer 21, second printer 22, and third printer 23) connected to the network (S13), receives response supplied, in response to the request, from the printers which are being searched (S14), and then causes a list of printers extracted as a result of the search to be displayed on the searched printer list display part 31 of FIG. 9 (S15). Note that the processes in S13 and S14 may be automatically carried out when the printer management list for administrator setting user interface (printer selection window) is displayed.

Next, the printer administrator selects printers that are available to general printer users from the printers displayed on the searched printer list display part 31, and then registers the printers thus selected (S16). The printers thus registered are displayed on the registered printer list display part 32.

Then, the printer administrator selects a default printer from the printers available to general printer users which printers are displayed on the registered printer list display part 32 (S17). When the printer administrator clicks an OK button 40 (S18), information indicative of (i) the printers displayed on the searched printer list display part 31 (the printers extracted as a result of the search), (ii) the printers displayed on the registered printer list display part 32 (the printers that are available to the general printer users), and (iii) the printer selected as the default printer is registered in the storage section 103.

Next, it is determined whether a unique print port which allows data to be outputted to the default printer (destination printer) is installed or not (S19). In a case where such a unique print port is installed, a process in S21 is carried out. Meanwhile, in a case where such a unique print port is not installed and where an OS (operating system) standard TCP/IP port is used as a print port, print ports for the printers registered as available printers in S16 are created (S20). Thus, print ports shown in the display 402 of FIG. 26 are created.

Next, the control section 101 requests, from the default printer, apparatus information indicative of printer functions such as a post-processing function (S21), and then acquires the apparatus information supplied, in response to the request, from the default printer (S22). The apparatus information thus acquired is stored in the storage section 103.

Subsequently, the control section 101 identifies the selected default printer (S23), and then causes a display on the display section 104 to be switched to a printer driver user interface corresponding to the default printer (S24). This allows the printer administrator to set various operations of the default printer.

Specifically, it becomes possible for the printer administrator to set an option in accordance with option information of the apparatus information of the default printer. For example, in a case where the default printer is a color printer provided with a finisher (staple finisher) having a staple function, a user interface which allows the printer administrator to set a color print function is selected, and is displayed on the display section 104 so that the color print function can be used. Alternatively, based on the apparatus information (provided with the staple finisher) acquired in advance, it becomes possible to select “staple finisher” in an option window. In this way, a printer driver user interface corresponding to a default printer is selected so that a user can use post-processing functions and the like of the default printer. Thus, the user can use various functions of the default printer.

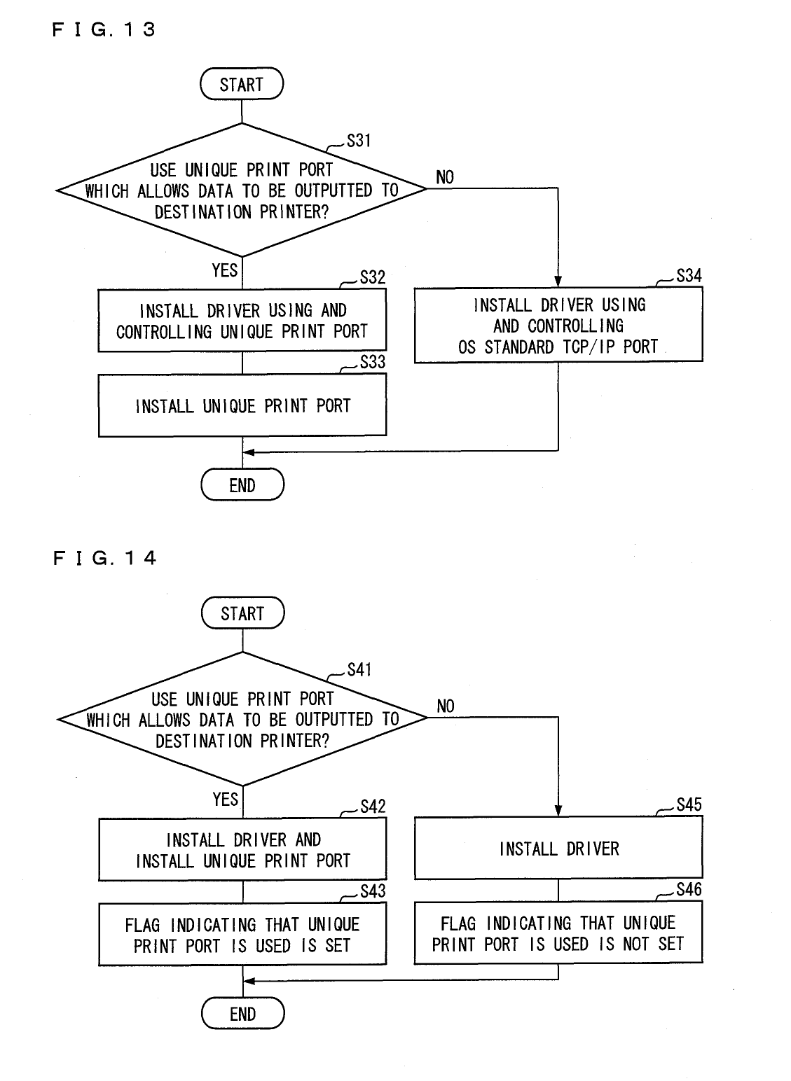

Next, print port creating processing is described. It is determined whether a unique port is created or a standard port is used, depending on what kind of processing is carried out when a printer driver is installed. Such processing is described below with reference to the flow chart of FIG. 13.

On an installer window for installing a printer driver in the PC 10, a user is requested to determine whether a unique print port is installed or not. In a case where, in response to the request, the user chooses to install the unique print port (S31), a printer driver in which the unique print port is used is installed (S32), and the unique print port is installed (S33).

Meanwhile, in a case where an OS (operating system) standard TCP/IP port is selected as a print port in S31, a printer driver in which the OS standard TCP/IP port is used is installed (S34).

Next, another example of the print port creating processing is described below with reference to the flow chart of FIG. 14.

On an installer window for installing a printer driver in the PC 10, a user is requested to determine whether a unique print port is installed or not. In a case where, in response to the request, the user chooses to install the unique print port (S41), a printer driver in which the unique print port is used is installed, and the unique print port is installed (S42). Then, a flag indicating that the unique port is used is set (S43).

Meanwhile, in a case where an OS standard TCP/IP port is selected as a print port in S41, a printer driver in which the OS standard TCP/IP port is used is installed (S45). Then, a flag indicating that the unique port is not used is set (S46).

Next, with reference to the flow chart of FIG. 15, the following description deals with how the printer driver of the present embodiment operates in a case where a setting program for general users is executed.

A general printer user who logged into the PC 10 causes the printer driver to display the printer management list for general user setting user interface (printer selection window) shown in FIG. 10. In response to this operation, the printer management list for general user setting user interface is displayed (S51). Note that the printer management list for general user setting user interface (printer selection window) may be automatically displayed in a case where the general user instructs execution of printing from an application.

Next, the general printer user carries out an input operation on the printer management list for general user setting user interface (printer selection window) so as to determine whether a default printer is switched to another one (S52). In response to this operation, the default printer is switched to another one (S53).

Next, the general printer user clicks an OK button 41 (S54). In response to this, a printer that is newly selected as a default printer is requested to supply apparatus information indicative of printer functions such as a post-processing function (S55). Then, the apparatus information supplied from the default printer in response to this request is acquired (S56). Information indicative of the default printer selected by the general printer user is stored in the storage section 103.

Subsequently, the control section 101 identifies the currently selected default printer (S57), and then causes a display on the display section 104 to be switched to a printer driver user interface corresponding to the currently selected default printer (S58). This allows an administrator of the general printer user to set various operations of the default printer.

For example, in a case where the default printer is a color printer provided with a finisher (staple finisher) having a staple function, a user interface which allows the administrator to set a color print function is selected, and is displayed on the display section 104 so that the color print function can be used. Alternatively, based on the apparatus information (provided with the staple finisher) acquired in advance, it becomes possible to select “staple finisher” in an option window.

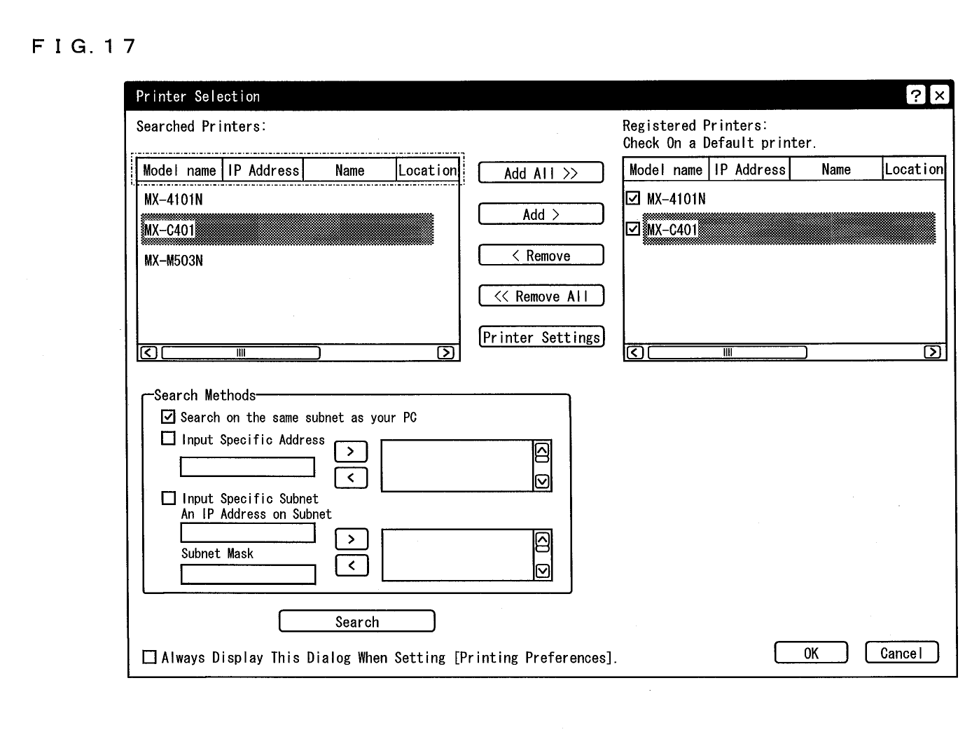

Meanwhile, in a case where the general user does not change the default printer in S52, the display section 104 displays a user interface corresponding to a default printer selected by the administrator. FIG. 17 illustrates an example of how the user interface shown in FIG. 9 is displayed in a case where the general printer user changes a default printer from the first printer 21 (monochrome printer), which has been selected by the printer administrator, to the second printer 22 (color printer).

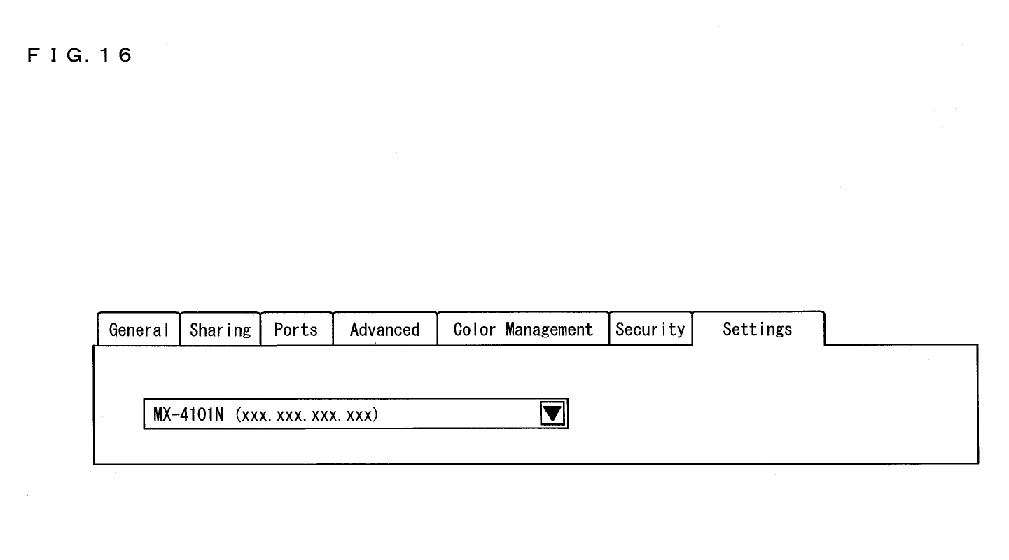

Note that another arrangement is possible in which the general printer user is not allowed to change the default printer selected by the printer administrator. In this arrangement, the processes in S55 and S56 are not carried out. Moreover, in the arrangement in which the general printer user is not allowed to change the default printer selected by the printer administrator, the window illustrated in FIG. 16 may be displayed, as a window for showing a default printer (destination printer), instead of the window illustrated in FIG. 10.

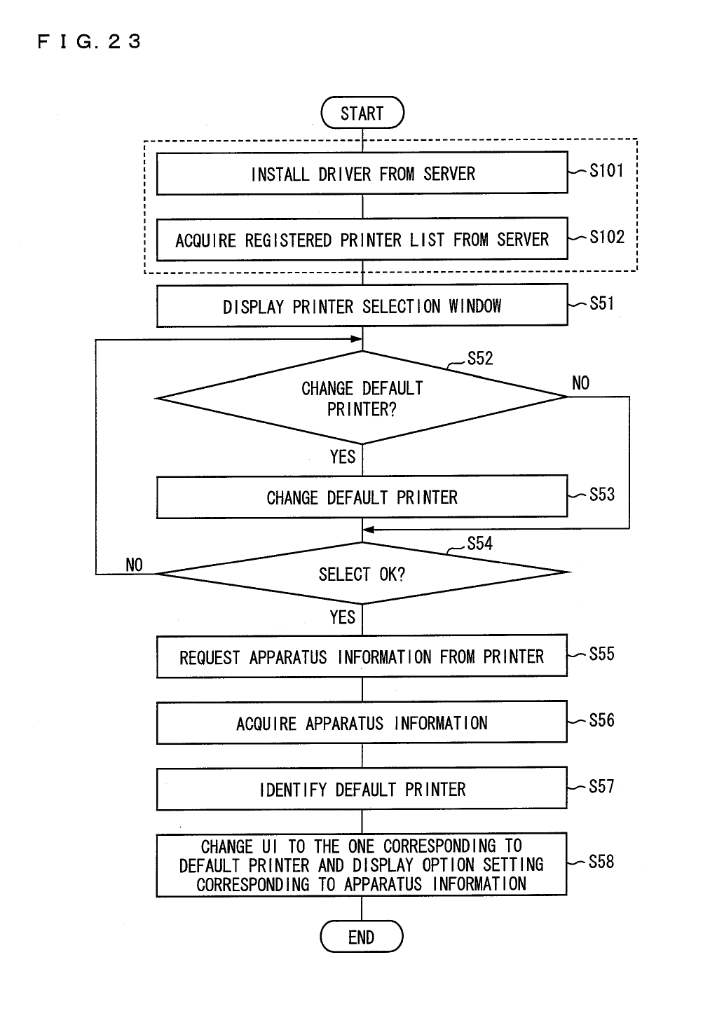

Moreover, in a case where the printer driver property window of FIG. 9 is displayed in response to an operation of the printer administrator, the window of FIG. 9 may be configured such that the printer administrator can select whether the window of FIG. 9 is always displayed or not. Similarly, in a case where the printer driver property window of FIG. 10 is displayed in response to an operation of a general printer user, the window of FIG. 10 may be configured such that the general printer user can select whether the window of FIG. 10 is always displayed or not. This selection can be carried out by checking or unchecking a checkbox of a regular display setting part 37 shown in each of FIGS. 9 and 10. In the flow chart of FIG. 12, the selection may be carried out at any timing between S11 through S18. In the flow charts of FIGS. 15 and 23, the selection may be carried out at any timing between S51 through S54. In a case where the checkbox of the regular display setting part 37 is checked, the control section 101 controls the display section 104 so that the display section 104 displays a user interface of a default printer as soon as a process in a flow chart starts.

In a case where the printer selection window is set to be always displayed as above, the printer selection window is displayed in response to selection of a print setting button on a print window of an application, for example. Thus, a user can change a destination printer. On the other hand, in a case where a user does not want to change a printer when printing from an application, the user does not want the printer selection window to be always displayed. In this case, the user is only required to uncheck the checkbox of the regular display setting part 37.

In a case where the printers which are registered, by the printer administrator, as printers available to general printer users include a printer to which data cannot be outputted such as an off-line printer, such a printer may be grayed out so as to be distinguished from available printers, as shown in FIG. 17. In this case, in a case where a list (first printer list) of printers connected to the network 11 is stored in advance, the first printer list is compared with a list (second printer list) of operating (ON) printers extracted by the latest search. Then, a printer which is included in the first printer list and which is not included in the second printer list is grayed out. According to the arrangement in which a printer to which data cannot be outputted is grayed out, it is possible to prevent a user from selecting such a printer as a destination printer.

In this case, before S15 in which printers (second printer list) extracted as a result of a search are displayed, the first printer list is read out. Next, the first printer list is compared with the second printer list acquired as a result of the search. Then, a printer which is included in the first printer list but is not included in the second printer list is grayed out in S15.

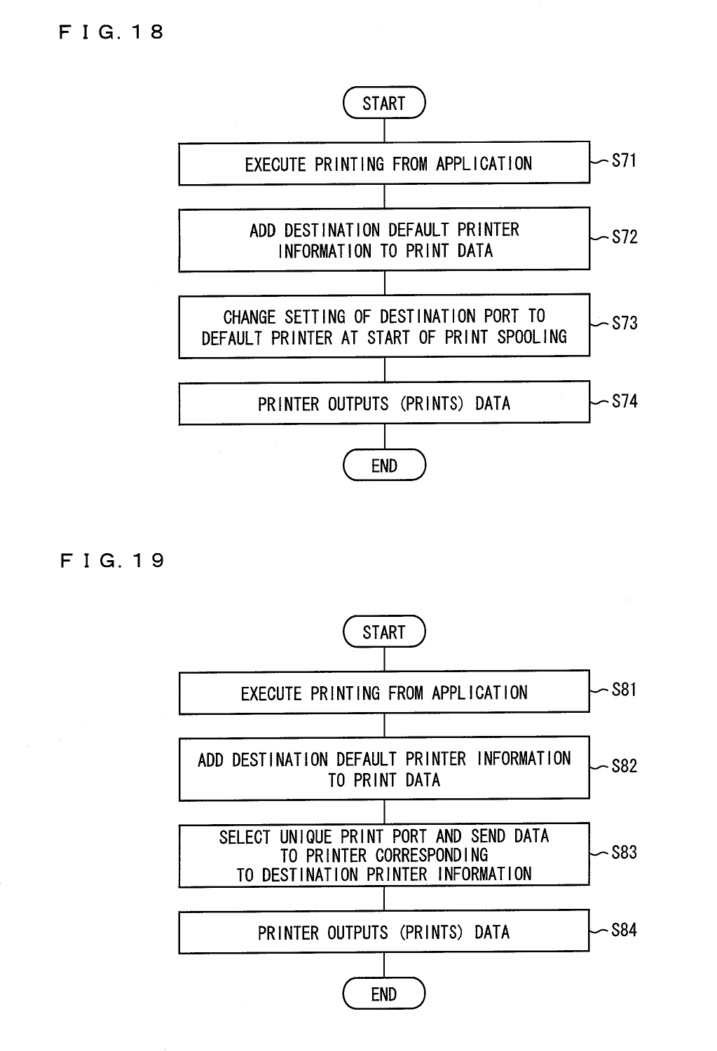

FIG. 18 is a flow chart showing how a printer driver operates in a case where a user executes printing in an arrangement in which an OS standard TCP/IP port is used.

As shown in FIG. 18, a user instructs execution of printing from an application (S71). In response to this instruction, print data (data in a so-called EMF data format) is created, and then default printer information indicative of a destination printer is added to the print data thus created (S72).

Next, at the start of print spooling, the default printer information is extracted from the print data, setting of a destination port is changed so that a default printer is selected, and the print data is outputted to the default printer (S73). In this case, it is possible that (i) only an identifier (e.g. printer name) of the selected default printer is preserved in the print data, (ii) identifiers of the respective available printers are preserved in a list of the available printers, and (iii) the identifier information of the selected default printer is compared with the identifiers preserved in the list so that destination printer information (e.g., IP address) can be acquired from the list. In response to the process in S73, the default printer carries out printing (S74).

In a specification in which an OS standard TCP/IP port is used, only a single print port can be allocated to a single printer driver because of the specification. Accordingly, in a case where a universal printer driver such as a universal printer driver of the embodiment of the present invention is used, setting of the port needs to be changed every time a default printer is changed. That is, in S73, setting of the print port must be changed based on the default printer information added to the print data.

FIG. 19 is a flow chart showing how a printer driver operates in a case where a user executes printing in an arrangement in which a unique print port is used.

As shown in FIG. 18, a user instructs execution of printing from an application (S81). In response to this instruction, print data in a format such as an EMF format is created, and then default printer information (e.g., IP address in PJL) indicative of a destination printer is added to the print data thus created (S82).

The unique print port selects a destination port corresponding to the default printer information added to the print data, and supplies the print data to the destination port (S83). Thus, the default printer carries out printing (S84).

In a case where a plurality of print ports are allocated to a single printer driver as above, a destination port can be selected from the plurality of print ports. Thus, print data can be outputted.

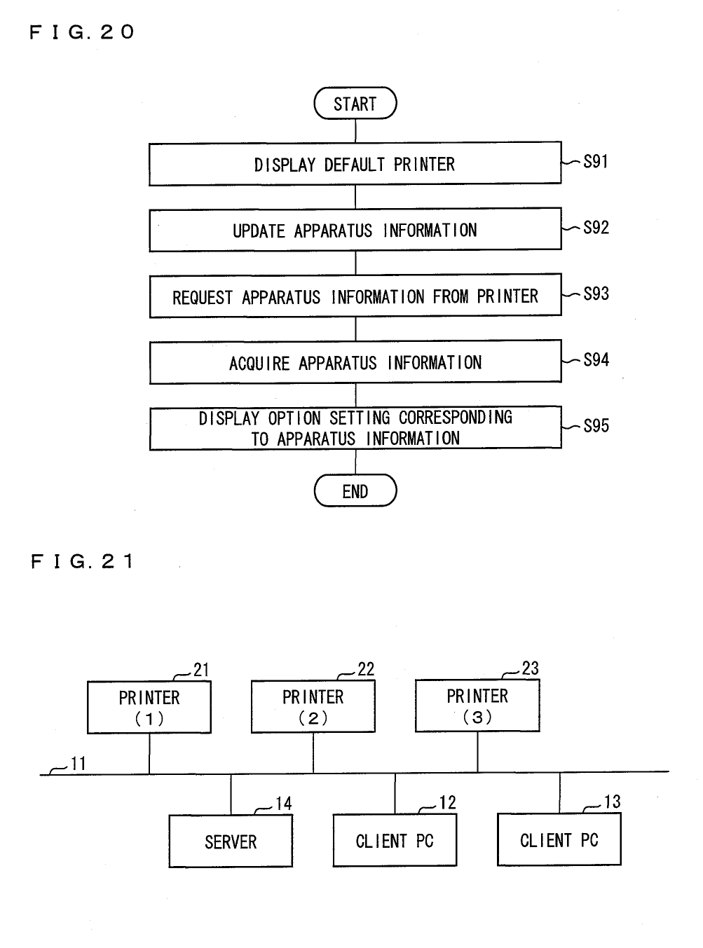

FIG. 20 is a flow chart showing another example of how a printer driver of the present embodiment operates in a case where a setting program for general users is executed. This example deals with a case where a general printer user is not allowed to change a default printer. Specifically, this example deals with a case where a list of available printers is not displayed, and therefore a general printer user is not allowed to change a printer, i.e., is allowed to use only a default printer selected by a printer administrator.

As illustrated in FIG. 16, in response to an operation of a general printer user who logged into the PC 10, a default printer available to the general printer user is displayed (S91).

Next, the general printer user instructs updating of apparatus information of the default printer (S92). In response to this instruction, the default printer is requested to supply its apparatus information (S93). Then, the apparatus information thus supplied in response to this request is acquired (S94).

Next, the control section 101 causes the display section 104 of the PC 10 to display a user interface corresponding to the apparatus information thus acquired (S95).

Note that another arrangement is possible in which the processes in S92 through S94 are not carried out. In this case, a user interface corresponding to information of the default printer selected by the printer administrator is displayed.

As described above, according to the printer control apparatus of the present embodiment, it is possible to prevent a user from using a printer that is not intended by an administrator even in a case where a universal printer driver, which can support plural kinds of printers, is used. Moreover, it is possible to restrict available printers although a universal printer driver, which can support plural kinds of printers, is used. This allows an administrator to determine, with much less labor, which printers are available and which printers are not available to users.

### Embodiment 2

Another embodiment of the present invention is described below with reference to the drawings. In the arrangement described in the Embodiment 1, in a case where a plurality of PCs 10 (client PCs) are connected to the network 11, a printer administrator needs to carry out an available printer setting operation with respect to each of the plurality of PCs 10. In view of this, the present embodiment deals with an arrangement which can reduce this burden of the printer administrator. Specifically, a server for managing installation of a printer driver is provided so that it is possible to collectively determine, in the server, which printers are available to users. From this server, a universal printer driver can be installed in each of the PCs 10. By installing the universal printer driver from the server, only printers selected by the printer administrator becomes available in each of the PCs. This makes it unnecessary for a printer administrator to carry out the available printer setting operation with respect to each of the PCs 10.

FIG. 21 is a block diagram illustrating a configuration of a printing system of the present embodiment. As illustrated in FIG. 21, a plurality of client PCs (client PC 12 and client PC 13), a server 14, and a plurality of printers (first printer 21, second printer 22, third printer 23) are connected to a network 11. The client PCs 12 and 13 correspond to the PC10. As login authorities in the client PCs 12 and 13, there are administrator authority and general user authority, as in the case of PC 10. A user can log into the client PCs 12 and 13 by using one of these login authorities.

FIG. 22 is an explanatory view showing an example of how the client PC 12, client PC 13, server 14, first printer 21, second printer 22, and third printer 23 are connected to one another in the printing system shown in FIG. 21 and which of the first printer 21, second printer 22, and third printer 23 is available to a printer administrator and general printer users. As illustrated in FIG. 22, each of the client PCs 12 and 13 is connected to the first printer 21, second printer 22, and third printer 23 via the server 14. As in Embodiment 1, among the first printer 21, second printer 22, and third printer 23 extracted as a result of a search, a general printer user is allowed to use only the first printer 21 and the second printer 22 by the printer administrator, i.e., is not allowed to use the third printer 23.

First, in the printing system of the present embodiment, a printer driver is installed in the server 14. Then, the printer administrator conducts the printer driver setting operation on the server 14. In this case, the server 14 in which the printer driver is installed operates in a similar manner to the flow chart of FIG. 12. Note that the printer driver is a so-called universal printer driver, which can support a plurality of printers by itself, as in Embodiment 1.

Next, users (general printer users) of the client PCs 12 and 13 access the server 14 from the client PCs 12 and 13 in order to install, in the client PCs 12 and 13, the printer driver whose setting has been already completed in the server 14, respectively. For example, under a circumstance of Microsoft Windows (registered trademark), the “Point and Print” function of the Microsoft Windows (registered trademark) allows the users to install the printer driver in the client PCs 12 and 13.

FIG. 23 is a flow chart showing an example of how the printer driver operates in a case where a setting program for general users is executed in the client PCs 12 and 13.

In FIG. 23, first, a general printer user accesses the server 14 so as to install the printer driver from the server 14 (S101). Next, a list of printers which are registered as printers available to general printer users, i.e., a printer management list 307 shown in FIG. 6 is acquired from the server 14 (S102). The subsequent processes in S51 through S58 are identical to those explained with reference to FIG. 15.

Once the printer driver is installed in the client PCs 12 and 13 from the server 14, it is naturally unnecessary to carry out the processes in S101 and S102. This means that next time, the process in S51 is carried out first.

In the flow chart of FIG. 18, which shows how the printer driver operates in a case where a user executes a printing operation in an arrangement in which an OS standard TCP/IP port is used, the processes in S73 and the subsequent steps are carried out in the server 14. Specifically, according to the printing system of the present embodiment, print data to be printed by a printer is supplied from the client PC 12 or 13 to the server 14, and is then supplied from the server 14 to one of the first printer 21, second printer 22, and third printer 23. Accordingly, a print port prepared in the server 14 is used. That is, a print port setting operation is carried out in the server 14.

Similarly, in the flow chart of FIG. 19, which shows how the printer driver operates in a case where a user executes a printing operation in an arrangement in which unique print ports are used, the processes in S80 and the subsequent steps are carried out in the server 14.

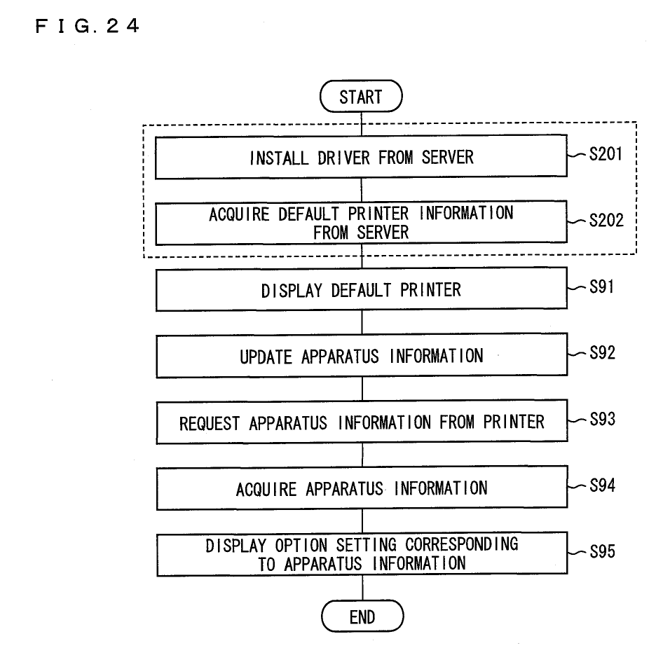

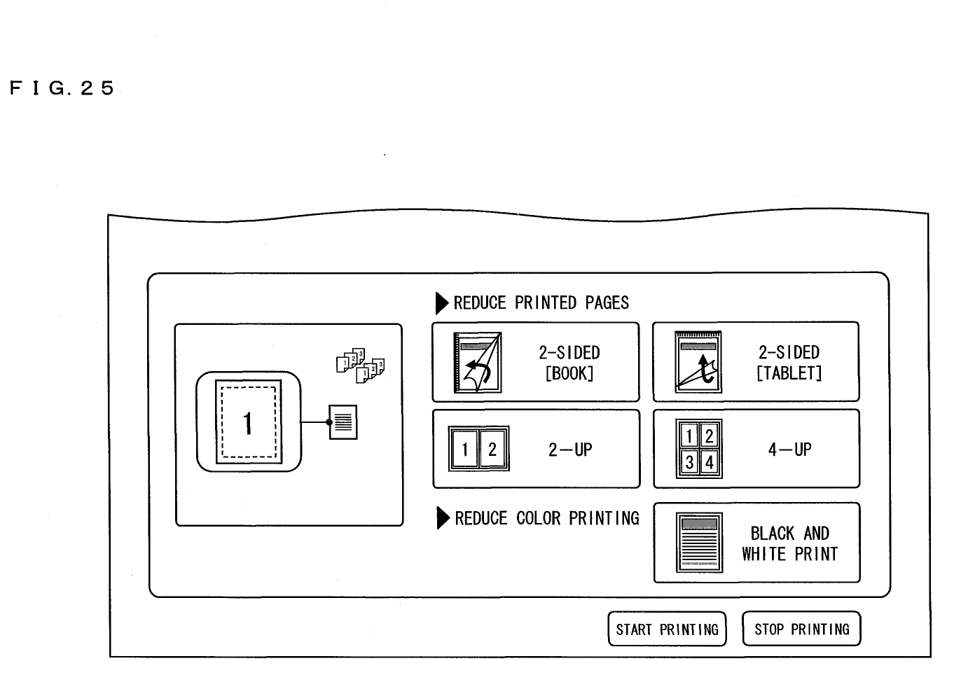

FIG. 24 is a flow chart showing another example of how the printer driver operates in a case where the setting program for general user is executed in the client PCs 12 and 13. Specifically, the flow chart of FIG. 25 shows a case where a general printer user cannot change a default printer.

In FIG. 24, first, a general printer user accesses the server 14 so as to install the printer driver from the server (S201). Then, information indicative of a printer registered as a default printer of the general printer user is acquired from the server 14 (S202). The subsequent processes in S91 through S95 are identical to those explained with reference to FIG. 20.

In a case where the printer driver is installed from the server 14 in S201, an executable step management table 310 shown in FIG. 6 which is set in the server 14 is installed along with the printer driver. Here, information indicating that a PC in which the printer driver is installed a “client” PC is stored in an OS section 201 (e.g., printer administrator authority storage section 301) of each of the client PCs 12 and 13. This makes it possible to prevent even a user who logged into the client PC 12 or 13 by using an administrator authority from changing settings of the printer driver.

FIG. 25 is an explanatory view illustrating another example of the user interface for general printer users illustrated in FIG. 10. The user interface for general printer users has the smaller number of items to be displayed, as compared to the user interface for printer administrator illustrated in FIG. 9. In view of this, the user interface for general printer users may be configured such that a display area for each item is made large as illustrated in FIG. 25 so that viewability and operability of the user interface can be improved.

Note that switching from the user interface for general printer users of FIG. 10 to the user interface for general printer users of FIG. 25 may be automatically carried out, for example, in a case where it is determined, in S58 of FIG. 15, that a login user is a general printer user, with reference to the printer administrator authority storage section 301.

Regarding functions of a distributed driver (installer), it is also possible that a super administrator who is superior to the printer administrator can restrict functions of a printer driver. In this case, the super administrator restricts printer administrator's use of a distributed driver itself.

Moreover, in the search step (S12 of FIG. 12) carried out by the searching module 313, the following processes may be carried out.

(1) Narrowing the Number of Printers to be Extracted on the Basis of a Model Selected by the Super Administrator

The number of printers to be extracted is narrowed on a narrowing condition that only a specific model is extracted or on a narrowing condition that only a specific model is not extracted. In this case, a file (text file) which contains, as narrowing conditions, a name of a model and information indicating whether the model is extracted or not is stored. The file is read out by a driver, and the narrowing conditions described in the file are set as printer search conditions.

(2) Narrowing the Number of Printers to be Extracted on the Basis of a Function Selected by the Super Administrator

The number of printers to be extracted is narrowed on a narrowing condition that only an apparatus which has a specific function (post-processing function, color print function, etc.) is extracted or on a narrowing condition that only an apparatus which has a specific function is not extracted. In this case, a file (text file) which contains, as narrowing conditions, a name of a function and information indicating whether a printer having the function is extracted or not is stored. The file is read out by a driver, and the narrowing conditions described in the file are set as printer search conditions.

Moreover, in S15 of FIG. 12, a list of printers extracted as a result of a search may be displayed on the searched printer list display part 31 in such a manner that the printers are sorted on the basis of a model or a function.

Moreover, on the interface created by the first print setting UI creating section 305 and the interface created by the second print setting UI creating section 306 of FIG. 6, the super administrator may determine, for each user, which function is available and which function is not available. In this case, a file (text file) in which user names and attributes (e.g., only monochrome print function can be used) of the respective users are registered is additionally stored. At a timing (S58 of FIG. 15) during operation of a printer driver, the driver conducts a search so as to find out whether a name of a user who logged into a PC is registered in the file or not. In a case where the name of the user is registered, an attribute of the user is read out. Thus, the user is prohibited to use a specific function. For example, in a case where the user is prohibited to use a color print function, an option for the color print function is not displayed or is grayed out on the interface.

Finally, the blocks of the printer control apparatus may be realized by way of hardware or software as executed by a CPU as follows:

The printer control apparatus includes a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the printer control apparatus, a computer-readable storage medium containing control program code (executable program, intermediate code program, or source program) for the printer control apparatus, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The printer control apparatus may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth, 802.11 wireless, HDR, mobile telephone network, satellite line, or terrestrial digital network. The present invention encompasses a computer data signal embedded in a carrier wave in which computer data signal the program code is embodied electronically.

As described above, a printer control apparatus of the present invention may be arranged so as to further include: a searching section which conducts a search so as to extract printers that are connected to the printer control apparatus via the network; a printer list creating section which creates, as the printer list, a list of printers that are extracted as a result of the search; and an apparatus information acquiring section which communicates with a default printer so as to acquire apparatus information indicative of functions of the default printer, the default printer being a printer selected as a destination printer from said at least one available printer, the display control section causing the display means to display a window for accepting an input for selecting the default printer from said at least one available printer and to display a window for accepting an input for print setting including an input for selecting a function to be used from the functions of the default printer that are indicated in the apparatus information.

According to the arrangement, the searching section conducts a search so that printers connected to the printer control apparatus via the network are extracted, the printer list creating section creates, as a printer list of the printers (printer list of plural kinds of printers) extracted as a result of the search. The display control section causes the display means to display the printer list and the window for accepting an input for selecting available printers from the printers included in the printer list. When the input for selecting the available printers is accepted on the window, only use of one or more printers thus selected is permitted by the available printer restricting section.

Further, the display control section causes the display means to display a window for accepting an input for selecting a default printer from the printers selected as the available printers. When the input for selecting the default printer is accepted on the window, the apparatus information acquiring section communicates with the default printer that is selected as a destination printer so as to acquire apparatus information indicative of functions of the default printer.

Further, the display control section causes the display means to display a window corresponding to the default printer, which window is for accepting an input for print setting including an input for selecting a function to be used from the functions of the default printer indicated by the apparatus information. On this window, a user can perform print setting including selection of a function of the default printer to be used.

In the printer control apparatus of the present invention, the series of operations allows a user to easily carry out selection of available printers, selection of a default printer, and print setting including selection of a function of the default printer to be used.

The printer control apparatus may be arranged so as to further include: an administrator authority judging section which judges whether the user has a printer administrator authority or not, the display control section causing the display means to display the printer list and the window for accepting the input for selecting said at least one available printer only in a case where the administrator authority judging section judges that the user has the printer administrator authority.

According to the arrangement, for example, the administrator authority judging section demands a user who is trying to log into the printer control apparatus to input a password indicating the user has a printer administrator authority, and in a case where the user inputs the password, determines that the user has the printer administrator authority. In a case where it is determined that the user has the printer administrator authority, the display means displays the printer list and the window for accepting an input for selecting the available printers.

This makes it possible to prevent a general user, who is not an administrator having a printer administrator authority, from fraudulently or arbitrarily changing the available printers.

The printer control apparatus may be arranged so as to further include: an administrator authority judging section which judges whether the user has a printer administrator authority or not, in the window for accepting the input for the print setting, the user being capable of changing the print setting so that a specific function out of the functions of the default printer that are indicated in the apparatus information cannot be selected, only in a case where the administrator authority judging section judges that the user has the printer administrator authority.

According to the arrangement, for example, the administrator authority judging section demands a user who is trying to log into the printer control apparatus to input a password indicating the user has a printer administrator authority, and in a case where the user inputs the password, determines that the user has the printer administrator authority. In a case where it is determined that the user has the printer administrator authority, the user can change setting on the window for accepting an input for print setting so that a specific function out of the functions of the default printer indicated by the apparatus information cannot be selected. This allows the administrator, who has the printer administrator authority, to prohibit a general user from using, in a default printer selected as a destination printer, a specific function out of the functions of the default printer.

The printer control apparatus may be arranged so as to further include: an administrator authority judging section which judges whether the user has a printer administrator authority or not, the display control section causing the display means to display the printer list, the window for accepting the input for selecting said at least one available printer, and the window for accepting the input for selecting the default printer only in a case where the administrator authority judging section judges that the user has the printer administrator authority, whereas in a case where the administrator authority judging section judges, after the input for selecting the default printer is accepted, that the user does not have the printer administrator authority, the display control section causing the display means to display a window in which only the default printer thus selected is shown.

According to the arrangement, it is possible to restrict printers available to general printer users to a default printer selected by the printer administrator. This makes it unnecessary for a general printer user to carry out a special operation such as switching of a printer.

The printer control apparatus may be arranged such that the searching section conducts the search by using designated subnet or IP address as a search condition.

According to the arrangement, the search is conducted based on a designated subnet or IP address. It is therefore possible to extract printers designated by the subnet or IP address (e.g., printers located within a predetermined range), instead of extracting all printers connected to the network.

The printer control apparatus may be arranged so as to further include: a print port creating section which creates a print port corresponding to said at least one available printer; a default printer information adding section which adds information indicative of the default printer to print data to be printed; and a print port changing section which, at a start of print spooling, changes a print port to the print port corresponding to the default printer.

According to the arrangement, at the start of print spooling, the print port is changed to a print port corresponding to the default printer. As such, in a case where a destination printer has been changed by another user, it is possible to prevent print data from being printed by an unintended destination printer.

The printer control apparatus may be arranged so as to further include: a default printer information adding section which adds information indicative of the default printer to print data to be printed; and a print data outputting section which, at a start of print spooling, outputs the print data to the default printer indicated by the information added to the print data.

According to the arrangement, a destination printer of each user to which print data is outputted can be changed without creating a plurality of print ports.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### REFERENCE SIGNS LIST

10: PC (printer control apparatus)
11: Network
21: First printer
22: Second printer
23: Third printer
101: Control section (display control section, available printer restricting section, administrator authority judging section, searching section, printer list creating section, apparatus information acquiring section, print port creating section, default printer information adding section, print port changing section, print data outputting section)
104: Display section (display means)
201: OS section (administrator authority judging section, print data outputting section)
202: Printer driver section (apparatus information acquiring section, default printer information adding section, available printer restricting section)
301: Printer administrator authority storage section (administrator authority judging section)
302: Port management module (print port changing section)
308: Printer management list for administrator setting UI creating section (display control section)
309: Printer management list for general user setting UI creating section (display control section)
307: Printer management list (available printer restricting section)
311: Port management module (print port creating section)
312: Printer search result list primary storage section (printer list creating section)
313: Searching module (searching section)

1. A printer control apparatus which controls plural kinds of printers by use of a universal printer driver which is capable of communicating with the plural kinds of printers via a network and which is capable of supporting the plural kinds of printers,
the printer control apparatus comprising:
a display control section which causes display means to display a printer list of the plural kinds of printers and a window for accepting an input for selecting at least one available printer from the plural kinds of printers included in the printer list; and
an available printer restricting section which allows a user to use only said at least one available printer.

2. The printer control apparatus according to claim 1, further comprising:
a searching section which conducts a search so as to extract printers that are connected to the printer control apparatus via the network;
a printer list creating section which creates, as the printer list, a list of printers that are extracted as a result of the search; and
an apparatus information acquiring section which communicates with a default printer so as to acquire apparatus information indicative of functions of the default printer, the default printer being a printer selected as a destination printer from said at least one available printer,
the display control section causing the display means to display a window for accepting an input for selecting the default printer from said at least one available printer and to display a window for accepting an input for print setting including an input for selecting a function to be used from the functions of the default printer that are indicated in the apparatus information.

3. The printer control apparatus according to claim 1, further comprising:
an administrator authority judging section which judges whether the user has a printer administrator authority or not,
the display control section causing the display means to display the printer list and the window for accepting the input for selecting said at least one available printer only in a case where the administrator authority judging section judges that the user has the printer administrator authority.

4. The printer control apparatus according to claim 2, further comprising:
an administrator authority judging section which judges whether the user has a printer administrator authority or not,
in the window for accepting the input for the print setting, the user being capable of changing the print setting so that a specific function out of the functions of the default printer that are indicated in the apparatus information cannot be selected, only in a case where the administrator authority judging section judges that the user has the printer administrator authority.

5. The printer control apparatus according to claim 2, further comprising:
an administrator authority judging section which judges whether the user has a printer administrator authority or not,
the display control section causing the display means to display the printer list, the window for accepting the input for selecting said at least one available printer, and the window for accepting the input for selecting the default printer only in a case where the administrator authority judging section judges that the user has the printer administrator authority, whereas in a case where the administrator authority judging section judges, after the input for selecting the default printer is accepted, that the user does not have the printer administrator authority, the display control section causing the display means to display a window in which only the default printer thus selected is shown.

6. The printer control apparatus according to claim 2, wherein:
the searching section conducts the search by using designated subnet or IP address as a search condition.

7. The printer control apparatus according to claim 2, further comprising:
a print port creating section which creates a print port corresponding to said at least one available printer;
a default printer information adding section which adds information indicative of the default printer to print data to be printed; and
a print port changing section which, at a start of print spooling, changes a print port to the print port corresponding to the default printer.

8. The printer control apparatus according to claim 2, further comprising:
a default printer information adding section which adds information indicative of the default printer to print data to be printed; and
a print data outputting section which, at a start of print spooling, outputs the print data to the default printer indicated by the information added to the print data.

9. The printer control apparatus according to claim 1, further comprising the display means.

10. A printer control method for controlling plural kinds of printers by use of a universal printer driver which communicates with the plural kinds of printers via a network and which is capable of supporting the plural kinds of printers,
the printer control method comprising the steps of:
causing display means to display a printer list of the plural kinds of printers and a window for accepting an input for selecting at least one available printer from the plural kinds of printers included in the printer list; and
allowing a user to use only said at least one available printer.

11. A printer control method for controlling plural kinds of printers by use of a universal printer driver which communicates with the plural kinds of printers via a network and which is capable of supporting the plural kinds of printers,
the printer control method comprising the steps of:
causing display means to display, in a server in which the universal printer driver is installed and which is connected to the network, a printer list of the plural kinds of printers and a window for accepting an input for selecting at least one available printer from the plural kinds of printers included in the printer list;
allowing a user to use only said at least one available printer; and
causing the universal printer driver thus set in the steps (a) and (b) to be installed in a printer control apparatus connected to the server.

12. A printing system comprising:
a printer control apparatus as set forth in claim 1; and
plural kinds of printers that are connected to the printer control apparatus via a network.

13. A computer-readable storage medium in which a program for causing a computer to function as each section of a printer control apparatus as set forth in claim 1 is stored.
